(19) United States
(12) Patent Application Publication
(10) Pub. No.: US 2024/0323820 A1
(43) Pub. Date: Sep. 26, 2024

(54) OPERATING METHOD OF USER EQUIPMENT IN WIRELESS COMMUNICATION SYSTEM AND USER EQUIPMENT THEREFOR

(71) Applicant: SAMSUNG ELECTRONICS CO, LTD., Suwon-si (KR)

(72) Inventors: Myungjoon SHIM, Suwon-si (KR); Dahae CHONG, Suwon-si (KR); Gunyoung KO, Suwon-si (KR); Beomkon KIM, Suwon-si (KR); Joohyun DO, Suwon-si (KR); Yujin SIM, Suwon-si (KR)

(73) Assignee: SAMSUNG ELECTRONICS CO, LTD., Suwon-si (KR)

(21) Appl. No.: 18/612,855

(22) Filed: Mar. 21, 2024

(30) Foreign Application Priority Data
Mar. 21, 2023 (KR) 10-2023-0036894
Aug. 9, 2023 (KR) 10-2023-0104348

(51) Int. Cl. H04W 48/16; H04L 5/00

(52) U.S. Cl. CPC H04W 48/16; H04L 5/0091

(57) ABSTRACT

An operating method of a user equipment in a wireless communication system includes dividing a first frequency band, from among a plurality of frequency bands, into a plurality of sub-bands, based on a first radio frequency technology (RAT), measuring peak powers of each sub-band of the plurality of sub-bands, determining at least one effective sub-band from among the plurality of sub-bands, based on the measured peak powers, detecting, based on the determining of the at least one effective sub-band, a first effective signal through a frequency search operation using a correlation component of a synchronization signal corresponding to at least one of the first frequency band and the at least one effective sub-band, and performing initial access to a cell, based on the detecting the first effective signal.

### CROSS-REFERENCE TO RELATED APPLICATIONS

This application is based on and claims priority under 35 U.S.C. § 119 to Korean Patent Application No. 10-2023-0036894, filed on Mar. 21, 2023, and Korean Patent Application No. 10-2023-0104348, filed on Aug. 9, 2023, in the Korean Intellectual Property Office, the disclosures of which are incorporated by reference herein in their entireties.

### BACKGROUND

The present disclosure relates generally to a wireless communication system, and more particularly, to a user equipment performing a frequency search operation and an operating method thereof.

New radio access technology (e.g., fifth generation (5G) and/or New Radio (NR)) communication systems may attempt to provide high-speed data services when compared to related communication systems, such as, but not limited to, Long Term Evolution (LTE), LTE Advanced (LTE-A), and the like. For example, the high speed services may include services that may need data throughputs of several gigabits per second (Gbps) and/or may be implemented using an ultra-wideband (UWB) radio access technology with a bandwidth of 100 MHz or more. However, it may be difficult to secure an ultra-wideband frequency of 100 MHz or more in a frequency band of hundreds of MHz and/or several GHz that may be used in the LTE and LTE-A systems, and as such, transmitting signals by using a wide frequency band in a frequency band of 6 GHz or more may be considered in the 5G communication systems. For example, in the 5G communication systems, the transmission rate may be increased by using a millimeter wave band such as, but not limited to, a 28 GHz band, a 60 GHz band, and the like.

Consequently, the frequency band in which a user equipment may have to search for a cell currently providing a service may increase when compared to a related communication system. Accordingly, resources (e.g., search time, power consumption) that may be needed to search for a cell by the user equipment may increase, and/or the throughput of the user equipment may decrease in a Dual SIM Dual Standby (DSDS) environment. That is, the overall performance of the user equipment may degrade when compared with a related communication system.

### SUMMARY

One or more example embodiments of the present disclosure provide an operating method of a user equipment and a user equipment therefor, for performing an initial access operation to an effective cell by dividing a frequency band into sub-bands and rapidly finding a target frequency in the sub-bands through a stepwise approach using power measurement of a received signal and a correlation component of a synchronization signal.

According to an aspect of the present disclosure, an operating method of a user equipment in a wireless communication system includes: dividing a first frequency band, from among a plurality of frequency bands, into a plurality of sub-bands, based on a first radio frequency technology (RAT), measuring peak powers of each sub-band of the plurality of sub-bands, determining at least one effective sub-band from among the plurality of sub-bands, based on the measured peak powers, detecting, based on the determining of the at least one effective sub-band, a first effective signal through a frequency search operation using a correlation component of a synchronization signal corresponding to at least one of the first frequency band and the at least one effective sub-band, and performing initial access to a cell, based on the detecting of the first effective signal.

According to an aspect of the present disclosure, an operating method of a user equipment in a wireless communication system includes dividing a first frequency band, from among a plurality of frequency bands, by a preset frequency size into N sub-bands, according to a first RAT, wherein N is a positive integer greater than zero, measuring peak powers of each sub-band of the N sub-bands, determining at least one effective sub-band from among the N sub-bands, based on the measured peak powers, detecting, based on the determining of the at least one effective sub-band, a first effective signal by performing a frequency search operation using a correlation component of a synchronization signal corresponding to at least one of the first frequency band and the at least one effective sub-band, and performing initial access to a cell, based on the detecting of the first effective signal.

According to an aspect of the present disclosure, a user equipment for wireless communication includes a power measurement circuit configured to measure peak powers of a first frequency band, from among a plurality of frequency bands, in units of sub-bands, and a baseband processor configured to receive the peak powers from the power measurement circuit, determine an effective sub-band based on the peak powers, detect a synchronization signal by performing a frequency search operation using a correlation component of the synchronization signal corresponding to at least one of the first frequency band and the effective sub-band, and perform initial access to a cell based on the detected synchronization signal.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a block diagram illustrating a wireless communication system, according to an embodiment;

FIG. 2 is a flowchart illustrating a method of initially accessing a cell by a user equipment, according to an embodiment;

FIG. 3 is a diagram illustrating a method of determining an effective sub-band from among a plurality of sub-bands by a user equipment, according to an embodiment;

FIG. 4 is a flowchart illustrating a method of determining an effective sub-band from among a plurality of sub-bands by a user equipment, according to an embodiment;

FIGS. 5A and 5B are diagrams illustrating a method of determining an effective sub-band from among a plurality of sub-bands by a user equipment, according to an embodiment;

FIG. 6 is a flowchart illustrating a method of determining an effective sub-band from among a plurality of sub-bands by a user equipment, according to an embodiment;

FIGS. 7A and 7B are diagrams illustrating a method of determining an effective sub-band from among a plurality of sub-bands by a user equipment, according to an embodiment;

FIG. 8 is a block diagram illustrating a user equipment, according to an embodiment;

FIG. 9 is a flowchart illustrating a method of initially accessing a cell by a user equipment, according to an embodiment;

FIG. 10 is a block diagram illustrating an electronic device, according to an embodiment; and

FIG. 11 is a conceptual diagram illustrating an Internet of Things (IoT) network system to which an embodiment is applied.

### DETAILED DESCRIPTION

Hereinafter, example embodiments of the present disclosure are described in detail with reference to the accompanying drawings.

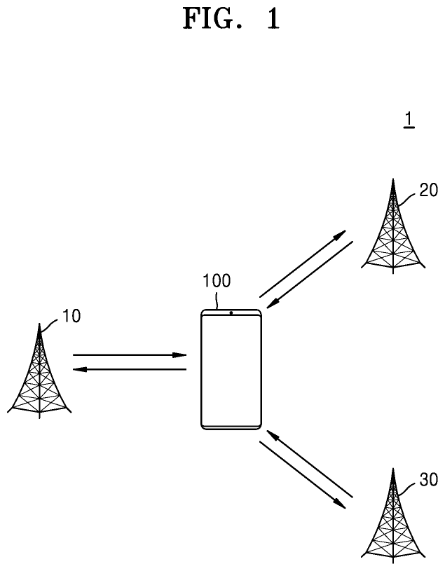

FIG. 1 is a block diagram illustrating a wireless communication system, according to an embodiment.

In the embodiments described below, a hardware-wise approach is described as an example. However, because the embodiments include technology using both hardware and software, the embodiments may not exclude software-based approaches.

Various functions described below may be implemented or supported by artificial intelligence (AI) technology and/or one or more computer programs, and each of the programs may include computer-readable program code and/or may be implemented in a computer-readable medium. The terms “application” and “program” may refer to one or more computer programs, software components, instruction sets, procedures, functions, objects, classes, instances, related data, or portions thereof suitable for implementation of suitable computer-readable program code. The term “computer-readable program code” may include all types of computer code including source code, object code, execution code, and the like. The term “computer-readable medium” may refer to all types of computer-accessible mediums such as, but not limited to, read only memories (ROMs), random access memories (RAMs), hard disk drives (HDDs), compact disks (CD), digital video disks (DVDs), or any other types of memories. “Non-transitory” computer-readable mediums may exclude wired, wireless, optical, or other communication links that transmit transient electrical and/or other signals. The non-transitory computer-readable mediums may include mediums in which data may be permanently stored and mediums such as rewritable optical disks and/or erasable memory devices in which data may be stored and overwritten later.

As illustrated in FIG. 1, a wireless communication system 1 may include a plurality of cells (e.g., first cell 10, second cell 20, and third cell 30) and a user equipment 100. For convenience of description, the wireless communication system 1 is illustrated as including only first to third cells 10 to 30. However, the illustration is not intended to be limiting, and thus, the present disclosure is not limited thereto. For example, the wireless communication system 1 may be implemented to include more or fewer cells.

The user equipment 100 may access the wireless communication system 1 by exchanging signals with the first to third cells 10 to 30. The wireless communication system 1 accessible by the user equipment 100 may be referred to as radio access technology (RAT). Hereinafter, the wireless communication system 1 accessed by the user equipment 100 may be described as based on a New Radio (NR) network (e.g., a 3rd Generation Partnership Project (3GPP) release. However, embodiments of the present disclosure are not be limited to the NR network and may also be applied to other wireless communication systems with similar technical backgrounds and/or channel settings (e.g., Long Term Evolution (LTE), LTE-advanced (LTE-A), wireless broadband (WiBro), global system for mobile communication (GSM), cellular communication systems such as sixth next-generation (6G) communication, non-terrestrial network (NTN) communication systems, and/or short-range communication systems such as Bluetooth™, Bluetooth™ Low Energy (BLE) and near field communication (NFC)).

A wireless communication network of the wireless communication system 1 may support a plurality of wireless communication equipment, including the user equipment 100, by sharing available network resources. For example, in the wireless communication network, information may be transmitted through various multiple access methods such as, but not limited to, Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), OFDM-FDMA, OFDM-TDMA, and OFDM-CDMA.

Each of the first to third cells 10 to 30 may generally refer to a fixed station communicating with the user equipment 100 and/or another cell and may communicate and/or exchange control information and/or data with the user equipment 100 and/or another cell. For example, each of the first to third cells 10 to 30 may be referred to as a Node B, an evolved Node B (eNB), a next generation Node B (gNB), a sector, a site, a base transceiver system (BTS), an access point, a relay node, a remote radio head (RRH), a radio unit (RU), a small cell, a wireless device, or the like. As used herein, the cell and/or base station may refer to a comprehensive meaning representing some areas or functions covered by a base station controller (BSC) in CDMA, a Node-B in WCDMA, an eNB and/or sector (site) in LTE, and the like and may cover all of various coverage areas such as mega cells, macro cells, micro cells, pico cells, femto cells, relay nodes, RRH, RU, and/or small cell communication ranges.

The user equipment 100 may be fixed and/or mobile and may refer to any equipment capable of communicating with a base station to exchange data and/or control information therewith. For example, the user equipment 100 may be referred to as a terminal, a terminal equipment, a mobile station (MS), a mobile terminal (MT), a user terminal (UT), a subscriber station (SS), a wireless device, a handheld device, and the like.

Referring to FIG. 1, the user equipment 100 may perform a cell search operation to find a cell currently providing a service. The cell search operation may refer to the user equipment 100 performing a frequency search operation and an initial access operation to identify cells located around the user equipment 100 to access a communication network.

The frequency search operation may refer to an operation of the user equipment 100 searching for a target frequency in a frequency list that may include past target frequencies. For example, the frequency list may be stored in a memory of the user equipment 100. Alternatively or additionally, when the user equipment 100 does not have a frequency list and/or fails to find a target frequency from the search for a target frequency in a frequency list, the frequency search operation may refer to an operation of searching for a target frequency in the entire frequency list supported by the user equipment 100. The frequency list may refer to a list including at least one frequency band that may be initially accessed based on the RAT supported by the user equipment 100. For example, when the user equipment 100 supports the RAT of NR, the frequency band may be any one of frequency bands of 6 GHz or less and/or millimeter wave frequency bands and the frequency list may include frequency bands of 6 GHz or less and/or millimeter wave frequency bands. The previously found frequency list may refer to at least one frequency band including a frequency by which the user equipment 100 has previously succeeded in initial access, and the target frequency may refer to a frequency for initial access based on the RAT supported by the user equipment 100.

The user equipment 100 may sequentially select a plurality of frequency bands and perform a cell search. For example, the user equipment 100 may perform a cell search by selecting a first frequency band from among a plurality of frequency bands and, when failing in the cell search, may perform a cell search by selecting a second frequency band.

The user equipment 100 may perform a frequency search operation by dividing a frequency band to be searched into sub-bands. In some embodiments, a sub-band may refer to bands into which the frequency band is divided by a preset unit based on the RAT supported by the user equipment 100. For example, when the preset unit is 5 MHz, a frequency band with a bandwidth of 100 MHz may be divided by 5 MHz into 20 sub-bands. Alternatively or additionally, the frequency band may be divided into more than 20 sub-bands by dividing the frequency band such that the sub-bands may partially overlap each other.

The user equipment 100 may perform a frequency search operation through a stepwise approach using a correlation component of a synchronization signal and measurement of a received peak power of a received signal of a plurality of sub-bands. As used herein, the received peak power may be interchangeably referred to as a peak power. In some embodiments, the user equipment 100 may measure a peak power of a received signal in each of the plurality of sub-bands. As another example, the user equipment 100 may measure peak powers of received signals in each of 20 sub-bands for a particular period.

In some embodiments, the user equipment 100 may determine at least one sub-band from among the plurality of sub-bands as an effective sub-band based on the measured peak powers of the received signal in each of the plurality of sub-bands. For example, the user equipment 100 may compare the peak powers of the received signal in each of 20 sub-bands with a threshold peak power and determine a sub-band with a value greater than or equal to the threshold peak power as an effective sub-band.

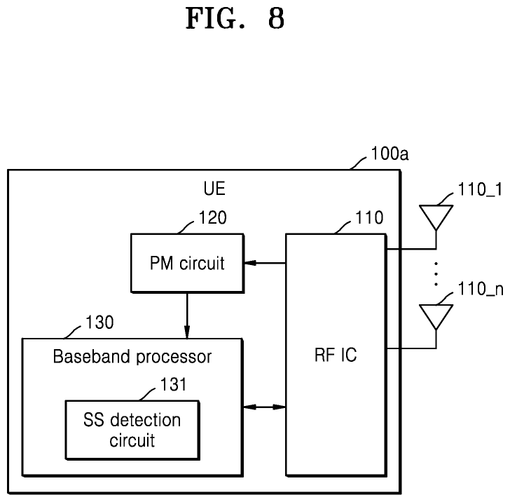

In some embodiments, the user equipment 100 may perform a frequency search operation using a correlation component of a synchronization signal corresponding to at least one sub-band of the frequency band. For example, when having determined at least one of the plurality of sub-bands as an effective sub-band, the user equipment 100 may perform a frequency search operation using a correlation component of a synchronization signal corresponding to the effective sub-band. As another example, when determining that there is no effective sub-band among the plurality of sub-bands, the user equipment 100 may perform a frequency search operation using a correlation component of a synchronization signal corresponding to all of the plurality of sub-bands. The frequency search operation using the correlation component of the synchronization signal is described with reference to FIG. 8.

In some embodiments, the user equipment 100 may detect an effective signal by performing a frequency search operation using a correlation component of a synchronization signal and may attempt initial access to at least one of the first to third cells 10 to 30 based on the detected effective signal. For example, the user equipment 100 may detect an effective signal (e.g., a primary synchronization signal (PSS), a secondary synchronization signal (SSS)) by performing a frequency search operation using a correlation component of a synchronization signal corresponding to a sub-band and may attempt initial access to at least one of the first to third cells 10 to 30 based on the detected effective signal.

The user equipment 100 may exchange signals with the cell by using a wide frequency band, and when a frequency search operation is performed on the entire supportable frequency band, a relatively long time may be taken to find a target frequency. The user equipment 100 may divide each frequency band by a preset unit into a plurality of sub-bands with respect to the entire supportable frequency band, determine at least one effective sub-band from among the plurality of sub-bands, and perform a frequency search operation on the effective sub-band and thus may find a target frequency faster than when a frequency search operation is performed on the entire frequency band. Accordingly, the initial access time may be reduced and thus the power consumption of the user equipment 100 may be reduced and the performance thereof may be improved, when compared to related user equipment.

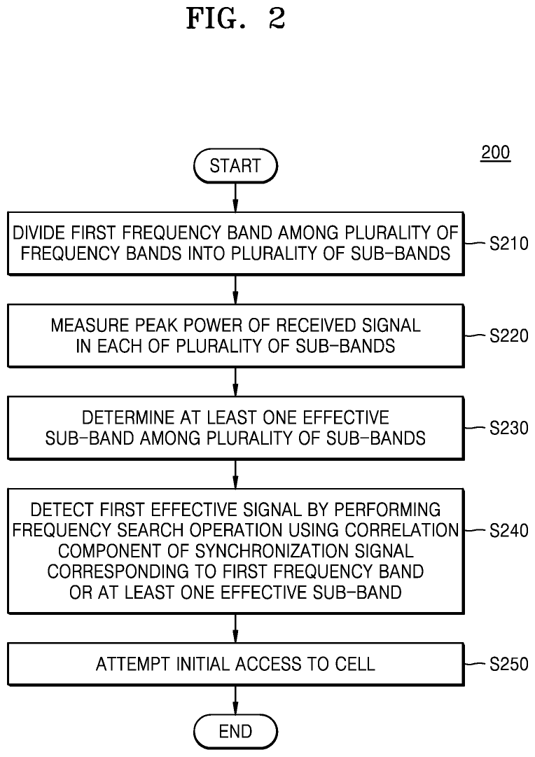

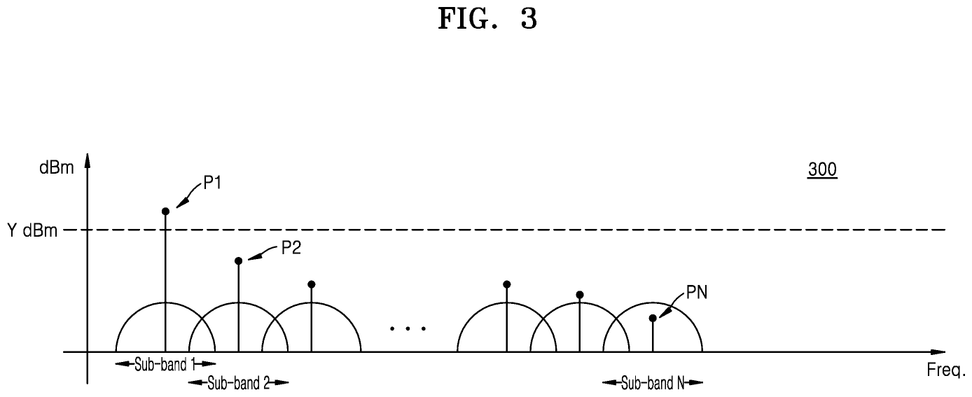

FIG. 2 is a flowchart illustrating a method of a user equipment initially accessing a cell by a user equipment, according to an embodiment. FIG. 3 is a diagram illustrating a method of determining an effective sub-band from among a plurality of sub-bands by a user equipment, according to an embodiment. Referring to FIG. 2, a method 200 of initially accessing a cell by a user equipment in a wireless communication system may include a plurality of operations S210 to S250.

Referring to FIGS. 1 and 2, in operation S210, the user equipment 100 may divide a first frequency band from among a plurality of frequency bands into a plurality of sub-bands. In some embodiments, the user equipment 100 may divide a first frequency band from among a plurality of frequency bands to be searched by a preset unit into N sub-bands, where N is a positive integer greater than zero (0). For example, when the preset unit is 5 MHz, the user equipment 100 may divide a frequency band with a bandwidth of 100 MHz by 5 MHz into 20 sub-bands and/or may divide the frequency band into more than 20 sub-bands by dividing the frequency band such that the sub-bands partially overlap each other.

In operation S220, the user equipment 100 may measure a peak power in each sub-band of the plurality of sub-bands. In some embodiments, the user equipment 100 may measure peak powers of a received signal in each of the N divided sub-bands. The peak power may refer to an average power for a unit time and/or the maximum power for a unit time.

In operation S230, the user equipment 100 may determine at least one effective sub-band from among the plurality of sub-bands. In some embodiments, the user equipment 100 may extract the maximum peak powers of the N sub-bands from the peak powers in each of the N divided sub-bands, compare the extracted maximum peak powers with a threshold peak power, and determine a sub-band corresponding to at least one maximum peak power greater than or equal to the threshold peak power as an effective sub-band. The maximum power peak may refer to a peak power with the greatest (e.g., maximum) value among the peak powers in each of the sub-bands. For example, one peak power corresponding to the greatest value among a plurality of peak powers of a sub-band may be referred to as the maximum peak power. The threshold peak power may be set based on a received signal strength indicator (RSSI), and the peak power may be measured based on the RSSI. The RSSI may refer to a relative signal strength and/or a power level received in a wireless communication environment (e.g., wireless communication system 1 of FIG. 1).

For example, referring to FIG. 3, the horizontal axis of a graph 300 may represent the frequency domain (Freq) and the vertical axis of the graph 300 may represent the level domain (dBm) of the peak power. Maximum peak powers P1 to PN may be respectively measured in N sub-bands Sub-band 1 to Sub-band N into which a first frequency band from among a plurality of frequency bands is divided by a preset unit. Each of the maximum peak powers P1 to PN may refer to the greatest (maximum) value from among the peak powers measured in each of the N sub-bands Sub-band 1 to Sub-band N. The user equipment 100 may compare each of the maximum peak powers P1 to PN of the N sub-bands Sub-band 1 to Sub-band N with a first threshold Y dBm. The user equipment 100 may determine the first sub-band Sub-band 1 corresponding to the maximum peak power P1 greater than or equal to the first threshold Y dBm from among the peak powers P1 to PN as an effective sub-band and may determine the other sub-bands Sub-band 2 to Sub-band N as ineffective sub-bands because the maximum peak powers P2 to PN may be less than the first threshold Y dBm as measured therein.

Returning to FIG. 2, in operation S240, the user equipment 100 may detect a first effective signal by performing a frequency search operation using a correlation component of a synchronization signal corresponding to the first frequency band and/or at least one effective sub-band. In some embodiments, when having determined at least one of the plurality of sub-bands as an effective sub-band, the user equipment 100 may perform a frequency search operation using a correlation component of a synchronization signal corresponding to the effective sub-band. When having failed to determine an effective sub-band from among the plurality of sub-bands, the user equipment 100 may perform a frequency search operation using a correlation component of a synchronization signal corresponding to the first frequency band. For example, based on the user equipment 100 having determined the first sub-band Sub-band 1 as an effective sub-band in operation S230, the user equipment 100 may perform a frequency search operation using a correlation component of a synchronization signal corresponding only to the first sub-band Sub-band 1 and may not perform a frequency search operation on the other sub-bands Sub-band 2 to Sub-band N. The user equipment 100 may detect a first effective signal (e.g., a PSS and/or an SSS) by performing a frequency search operation using a correlation component of a synchronization signal corresponding to the first sub-band Sub-band 1. The frequency search operation using the correlation component of the synchronization signal is described with reference to FIG. 8.

In operation S250, the user equipment 100 may perform initial access to the cell. In some embodiments, the user equipment 100 may attempt initial access to at least one of the first to third cells 10 to 30 based on the detected first effective signal. For example, the user equipment 100 may detect a first effective signal (e.g., a PSS and/or an SSS) in the first sub-band Sub-band 1 and may attempt initial access to at least one of the first to third cells 10 to 30 based on the first effective signal.

The user equipment 100 may divide a first frequency band into N sub-bands Sub-band 1 to Sub-band N, determine at least one of the N sub-bands Sub-band 1 to Sub-band N as an effective sub-band, and perform a frequency search operation only on the effective sub-band (e.g., Sub-band 1), and thus, may find a target frequency faster than when a frequency search operation is performed on the entire frequency band. Accordingly, the initial access time may be reduced, and the power consumption of the user equipment 100 may be reduced and the performance thereof may be improved, when compared to related user equipment.

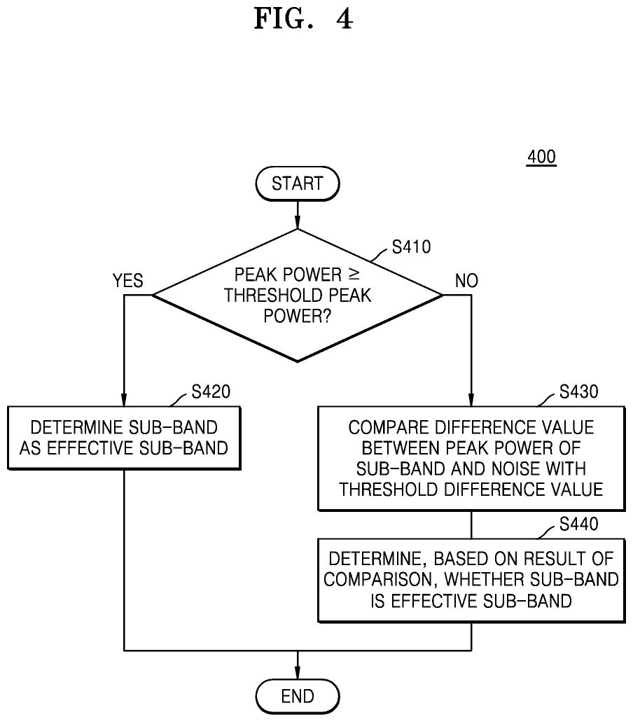

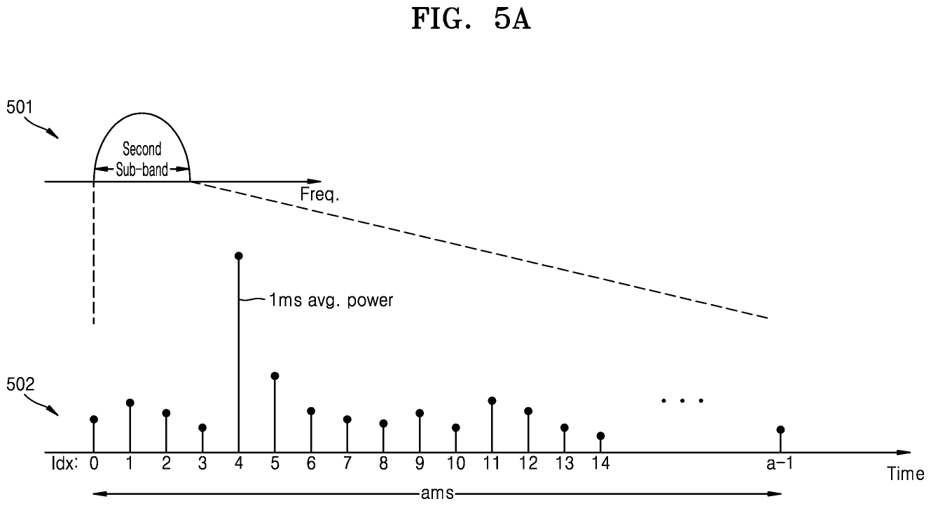

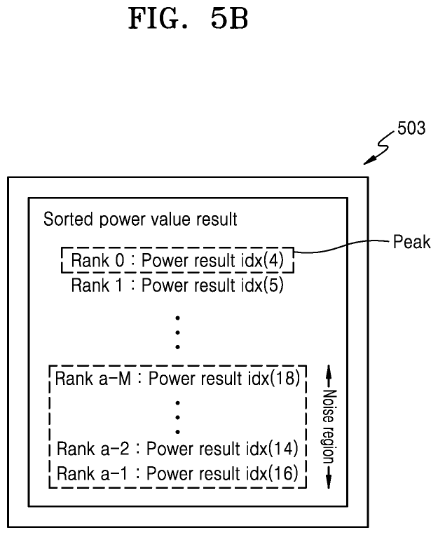

FIG. 4 is a flowchart illustrating a method of determining an effective sub-band from among a plurality of sub-bands by a user equipment, according to an embodiment. FIGS. 5A and 5B are diagrams illustrating a method of determining an effective sub-band from among a plurality of sub-bands by a user equipment, according to an embodiment. Referring to FIG. 4, a method 400 of a user equipment determining at least one effective sub-band from among a plurality of sub-bands in a wireless communication system may include a plurality of operations S410 to S440. The method 400 of a user equipment determining at least one effective sub-band from among a plurality of sub-bands in a wireless communication system may include and/or may be similar in many respects to operation S230 of FIG. 2, and may include additional features not mentioned above. Consequently, repeated descriptions of the method 400 described above with reference to FIG. 2 may be omitted for the sake of brevity.

Referring to FIGS. 1 and 4, the user equipment 100 may compare a peak power with a threshold peak power in operation S410 and, when the peak power has a value greater than or equal to the threshold peak power (YES in operation S410), may determine a sub-band corresponding to the peak power as an effective sub-band in operation S420. In some embodiments, the user equipment 100 may determine a first sub-band (e.g., Sub-band 1 of FIG. 3) corresponding to a peak power greater than or equal to the threshold peak power from among the plurality of sub-bands as an effective sub-band.

When the peak power has a value less than the threshold peak power in operation S410 (NO in operation S410), the user equipment 100 may calculate a difference value between the peak power of a sub-band having the peak power and the noise thereof and compare the difference value with a threshold difference value in operation S430. In some embodiments, with respect to a second sub-band (e.g., at least one sub-band from among Sub-bands 2 to Sub-band N of FIG. 3) corresponding to the maximum peak power less than the threshold peak power from among the plurality of sub-bands, the user equipment 100 may calculate a difference value between the maximum peak power of the second sub-band and the noise of the second sub-band and compare the difference value with a threshold difference value. The noise may be an average of lower M peak powers from among the measured peak powers of the second sub-band (e.g., the peak powers measured in operation S220 of FIG. 2), where M is a positive integer greater than zero (0).

For example, referring to FIGS. 5A and 5B, a graph 501 may be a graph representing the second sub-band on the frequency domain (Freq) and a graph 502 may be a graph representing the peak powers in the second sub-band measured by the user equipment 100 for a particular period (e.g., one (1) millisecond (ms)) on the time domain (Time) corresponding to time indexes idx(0) to idx(a−1). For example, the time indexes idx(0) to idx(a−1) may be at 1 ms intervals, and each of the peak powers in the second sub-band corresponding to each of the time indexes idx(0) to idx(a−1) may refer to an average power and/or a maximum power for a time period between two adjacent time indexes (e.g., 1 ms). The user equipment 100 may sort the peak powers of the second sub-band in descending order according to the values thereof, and a block diagram 503 may be a block diagram representing the peak powers sorted in descending order. In the block diagram 503 of FIG. 5B, the peak powers of the second sub-band corresponding to the time indexes idx(0) to idx(a−1) may be sorted into ranks (e.g., zero-th rank Rank 0 to (a−1)-th rank Rank a−1) according to the values thereof, and the peak power corresponding to the highest rank Rank 0 (corresponding to the fourth time index (idx(4)) may be the maximum peak power of the second sub-band. The noise may be an average of the peak powers of the lower M ranks (e.g., (a-M)-th rank Rank a-M to (a−1)-th rank Rank a−1). The user equipment 100 may measure the noise of at least one sub-band corresponding to a maximum peak power less than a particular threshold (e.g., the first threshold Y dBm of FIG. 3) among the maximum peak powers. The user equipment 100 may generate adjusted maximum peak powers corresponding to the difference value between the maximum peak power and the noise by subtracting the measured noise from the maximum peak power of the sub-band corresponding to the maximum peak power less than a certain threshold.

In some embodiments, the user equipment 100 may set a value of M based on the other intervals other than the interval in which synchronization signal block (SSB) may occur depending on the frequency size of the sub-band, and a noise value may be determined based on the set M.

In operation S440, based on the result of the comparison, the user equipment 100 may determine whether the sub-band is an effective sub-band. In some embodiments, the user equipment 100 may determine the second sub-band as an effective sub-band when the difference value calculated in operation S430 is greater than or equal to the threshold difference value and may determine the second sub-band as an ineffective sub-band when the difference value calculated in operation S430 is less than the threshold difference value. For example, the user equipment 100 may determine, as an effective sub-band, at least one sub-band corresponding to at least one adjusted maximum peak power greater than or equal to a second threshold from among the adjusted maximum peak powers.

In the wireless communication system 1, the measured peak power may vary depending on the surrounding environment of the user equipment 100, and as such, the effective signal may be detected more accurately when the noise caused by the surrounding environment is considered. The user equipment 100 determines whether the sub-band is an effective sub-band by comparing the noise with the maximum peak power with respect to the sub-band with the maximum power peak less than the threshold power peak, and thereby, the accuracy of the frequency search operation may be improved and the target frequency may be rapidly found, when compared to related user equipment. Accordingly, the initial access time may be reduced and thus the power consumption of the user equipment 100 may be reduced and the performance thereof may be improved, when compared to related user equipment.

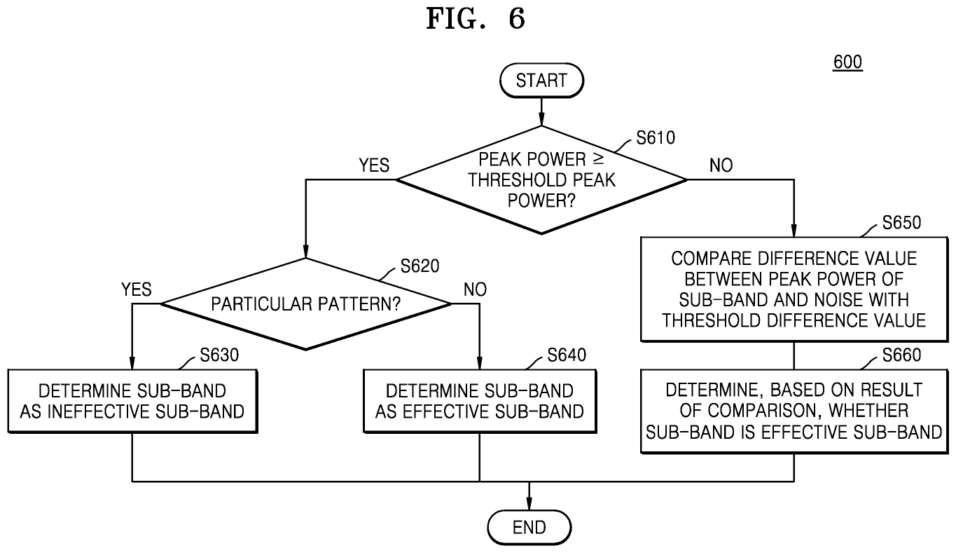

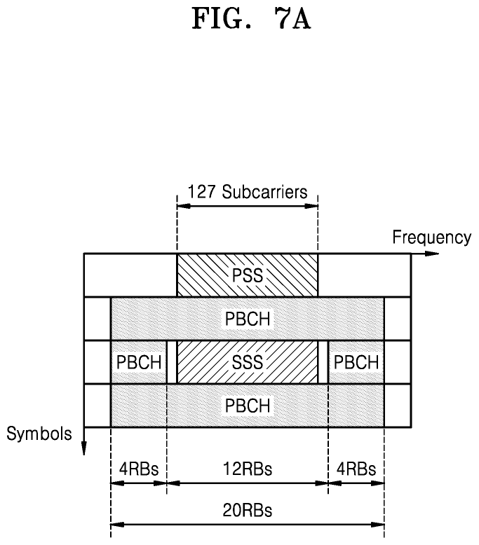

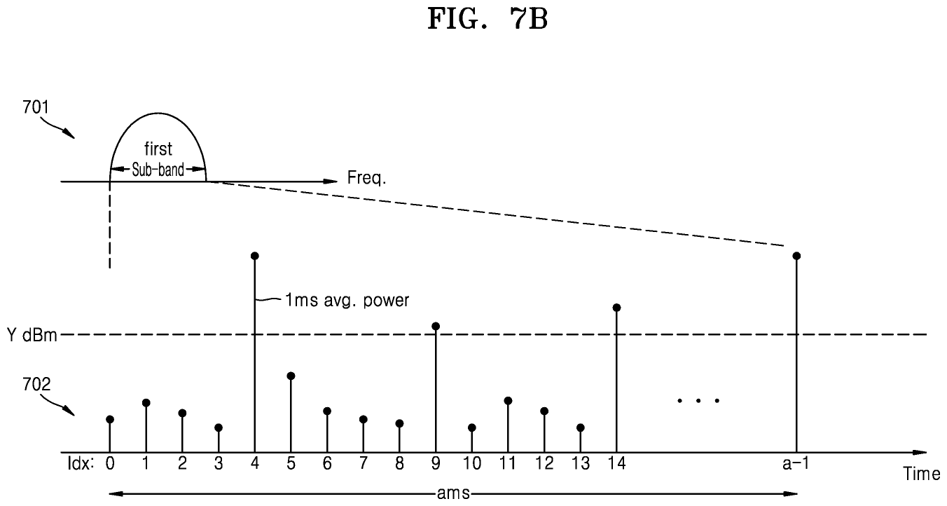

FIG. 6 is a flowchart illustrating a method of determining an effective sub-band from among a plurality of sub-bands by a user equipment, according to an embodiment. FIGS. 7A and 7B are diagrams illustrating a method of determining an effective sub-band from among a plurality of sub-bands by a user equipment, according to an embodiment. Referring to FIG. 6, a method 600 of a user equipment determining at least one effective sub-band from among a plurality of sub-bands in a wireless communication system may include a plurality of operations S610 to S660. The method 600 of a user equipment determining at least one effective sub-band from among a plurality of sub-bands in a wireless communication system may include and/or may be similar in many respects to operation S230 of FIG. 2, and may include additional features not mentioned above. Consequently, repeated descriptions of the method 600 described above with reference to FIG. 2 may be omitted for the sake of brevity.

Referring to FIGS. 1 and 6, operations S610, S650, and S660 may include and/or may be similar in many respects to operations S410, S430, and S440 of FIG. 4, respectively, and may include additional features not mentioned above. Consequently, repeated descriptions of operations S610, S650, and S660 described above with reference to FIG. 4 may be omitted for the sake of brevity.

When the peak power has a value greater than or equal to the threshold peak power in operation S610 (YES in operation S610), the user equipment 100 may determine, in operation S620, whether the measured power has a particular pattern. In some embodiments, the user equipment 100 may determine whether the measured peak power of a first sub-band (e.g., Sub-band 1 of FIG. 3) with a maximum peak power greater than or equal to the threshold peak power from among the plurality of sub-bands has a particular pattern. The particular pattern may refer to a pattern in which the power greater than or equal to the threshold peak power is measured at certain time intervals.

For example, referring to FIG. 7A, the diagram of FIG. 7A may be a diagram representing the time-frequency structure of an SSB that may include a PSS, an SSS, a physical broadcast channel (PBCH), and the like. In some embodiments, the SSB may include four symbols, and the PSS, the SSS, and the PBCH may be located at positions corresponding to certain resource blocks RBs in the direction of the frequency axis. In some embodiments, one resource block RB may include 12 consecutive subcarriers. In some embodiments, the PSS corresponding to the first symbol may be transmitted to the terminal through 127 subcarriers. Two SSBs may be arranged in one slot of the signal, and the first to third cells 10 to 30 may transmit the signal to the user equipment 100 for a certain SSB period. In some embodiments, assuming an NR with 15 kHz subcarrier spacing is applied to the wireless communication system 1, the length of one slot may be 1 ms and the SSB period may be 20 ms. As another example, assuming an LTE is applied to the wireless communication system 1, the SSB period may be 5 ms. However, the present disclosure is not limited in this regard, and the length of one slot may vary depending on the size of subcarrier spacing, the synchronization signal period set in the first to third cells 10 to 30, the time interval allocated for cell search, and the like.

Referring to FIG. 7B, a graph 701 may be a graph representing the first sub-band on the frequency domain (Freq) and a graph 702 may be a graph representing the peak powers in the first sub-band measured by the user equipment 100 for a particular period (e.g., one (1) ms) on the time domain (Time) corresponding to time indexes idx′(0) to idx′(a−1). Each of the peak powers of the first sub-band corresponding to the time indexes idx′(0) to idx′(a−1) may refer to an average power for 1 ms and/or a maximum power for 1 ms. Among the peak powers of the first sub-band corresponding to the time indexes idx′(0) to idx′(a−1), peak powers greater than or equal to the first threshold Y dBm (e.g., peak powers corresponding to idx′(4), idx′(9), idx′(14), and/or the like) may have a pattern with a certain time interval (e.g., b ms). When the first to third cells 10 to 30 support LTE, the SSB period may be 5 ms and the measured peak power in the sub-band including the SSB may be greater than or equal to the first threshold Y dBm. Thus, when the first sub-band has a measured peak power greater than or equal to the first threshold Y dBm at certain time intervals (e.g., b ms), the signal including the SSB received from the cell supporting the LTE may be included in the first sub-band and the user equipment 100 may determine that the measured peak power in the first sub-band has a particular pattern.

Returning to FIG. 6, when determining in operation S620 that the measured power has a particular pattern (YES in operation S620), the user equipment 100 may determine the sub-band having a particular pattern as an ineffective sub-band in operation S630. In some embodiments, the user equipment 100 may determine the first sub-band having a particular pattern as an ineffective sub-band. The user equipment 100 may not perform a frequency search operation on the first sub-band and/or may postpone a frequency search operation on the first sub-band as a lower priority.

For example, in the case of the user equipment 100 supporting the RAT of NR, signal communication with the cell may be smooth when initial access is first performed to the cell supporting the NR rather than the cell supporting the LTE. Because the first sub-band having a particular pattern may include a signal transmitted by the cell supporting the LTE, the user equipment 100 may determine the first sub-band as an ineffective sub-band and may not perform a frequency search operation using a correlation component of a synchronization signal on the first sub-band. Alternatively or additionally, the user equipment 100 may determine the first sub-band as an ineffective sub-band, perform a frequency search operation using a correlation component of a synchronization signal on other effective sub-bands, and then last perform a frequency search operation using a correlation component of a synchronization signal on the first sub-band.

When determining in operation S620 that the measured power does not have a particular pattern (NO in operation S620), the user equipment 100 may determine the sub-band not having a particular pattern as an effective sub-band in operation S640. In some embodiments, the user equipment 100 may determine the first sub-band not having a particular pattern as an effective sub-band. For example, when the measured power does not have a particular pattern, the signal including the SSB received from the cell supporting the NR may be included in the first sub-band and the user equipment 100 supporting the RAT of NR may determine the first sub-band as an effective sub-band.

In the case of the user equipment supporting the RAT of NR, the user equipment 100 may determine a sub-band having a particular pattern as an ineffective sub-band and may not perform a frequency search operation on the sub-band or may postpone the same as a lower priority. Accordingly, initial access may be performed by first searching for the cell supporting the NR rather than the cell supporting the LTE and the initial access time may be reduced and thus the power consumption of the user equipment 100 may be reduced and the performance thereof may be improved, when compared to a related user equipment.

FIG. 8 is a block diagram illustrating a user equipment, according to an embodiment. In some embodiments, a user equipment 100a of FIG. 8 may be include and/or may be similar in many respects to the user equipment 100 of FIG. 1, and may include additional features not mentioned above. Consequently, repeated descriptions of the user equipment 100a described above with reference to FIG. 1 may be omitted for the sake of brevity.

Referring to FIG. 8, the user equipment 100a may include a radio frequency (RF) integrated circuit 110, a plurality of antennas (e.g., first antenna 110_1 to n-th antenna 110_n, where n is a positive integer greater than zero (0)), a power measurement circuit 120, and a baseband processor 130.

The number and arrangement of components of the user equipment 100a shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. For example, the power measurement circuit 120 may be included in the RF integrated circuit 110 and/or may be included in the baseband processor 130. Alternatively or additionally, a set of (one or more) components shown in FIG. 8 may be integrated with each other, and/or may be implemented as an integrated circuit, as software, and/or a combination of circuits and software.

The RF integrated circuit 110 may receive, through the plurality of antennas 110_1 to 110_n, RF signals transmitted by at least one of the first to third cells 10 to 30 of FIG. 1. The RF integrated circuit 110 may generate intermediate frequency and/or baseband signals by down-converting the received RF signals to baseband signals. The RF integrated circuit 110 may generate data signals by filtering, decoding, and/or digitizing the intermediate frequency or baseband signals. Alternatively or additionally, the data signals may be encoded, multiplexed, and/or analog-converted. The RF integrated circuit 110 may up-convert the intermediate frequency or baseband signals and transmit the results thereof as RF signals through the plurality of antennas 110_1 to 110_n. The RF integrated circuit 110 may include a transmission filter, a reception filter, an amplifier, a mixer, an oscillator, a digital-to-analog converter (DAC), an analog-to-digital converter (ADC), and/or the like. The RF integrated circuit 110 may further include a plurality of RF chains and may perform beamforming using the plurality of antennas 110_1 to 110_n. The RF integrated circuit 110 may adjust the phase and/or amplitude of each of the signals transmitted/received through the plurality of antennas 110_1 to 110_n for beamforming. The RF integrated circuit 110 may perform Multi Input Multi Output (MIMO) and/or may receive multiple layers when performing a MIMO operation. The RF integrated circuit 110 may be referred to as a transmitter, a receiver, a transceiver, a communicator, and the like. In some embodiments, the RF integrated circuit 110 may receive a signal for each of the N sub-bands through the plurality of antennas 110_1 to 110_n and transmit the signal for each of the N sub-bands to the power measurement circuit 120.

The power measurement circuit 120 may measure the power in each of the N sub-bands. In some embodiments, the power measurement circuit 120 may measure the peak power in each of the N sub-bands, and the power having the highest value among the powers measured for a particular period may be referred to as the maximum peak power.

The baseband processor 130 may control various operations related to the wireless communication with the cell (e.g., first cell 10, second cell 20, third cell 30) of the user equipment 100a, may receive a measured peak power from the power measurement circuit 120, and may determine an effective sub-band based on the measured peak power. In some embodiments, the user equipment 100a may compare the maximum peak power in each of the N divided sub-bands with a threshold peak power. The threshold peak power may be set based on the RSSI. The user equipment 100a may determine a sub-band corresponding to a maximum peak power greater than or equal to the threshold peak power as an effective sub-band.

The baseband processor 130 may include a synchronization signal (SS) detection circuit 131 detecting a synchronization signal. The synchronization signal detection circuit 131 may search for the frequency of the sub-band to be searched in channel raster units (e.g., 15 kHz, 100 kHz) and may set the channel to be searched for while changing the channel number depending on an absolute radio frequency channel number (ARFCN). In some embodiments, the synchronization signal detection circuit 131 may detect a synchronization signal by performing a frequency search operation using a correlation component of a synchronization signal in the effective sub-band. For example, the synchronization signal detection circuit 131 may detect a peak value when there is a correlation component between reference signal sequences and an SSB with respect to the ARFCN in the effective sub-band and may determine, when the peak value is detected, that there is a synchronization signal in the effective sub-band. Also, when the peak value is not detected, the synchronization signal detection circuit 131 may determine that there is no synchronization signal.

In some embodiments, when the baseband processor 130 determines that there is no effective sub-band among the N sub-bands, the synchronization signal detection circuit 131 may detect a synchronization signal by performing a frequency search operation using a correlation component of a synchronization signal corresponding to all of the N sub-bands. For example, the synchronization signal detection circuit 131 may detect a peak value when there is a correlation component between the reference signal sequences and the SSB with respect to the ARFCN in each of the N sub-bands and may determine that there is a synchronization signal in the sub-band in which the peak value has been detected. When the peak value is not detected, the synchronization signal detection circuit 131 may determine that there is no synchronization signal.

The baseband processor 130 may perform initial access to the cell based on the detected synchronization signal. In some embodiments, the synchronization signal may include a PSS, and the baseband processor 130 may determine, from the detected PSS, timing (e.g., 5 ms timing) information of the cell, the position of an SSS, and a cell identification (ID) number in a cell ID group. Thereafter, the baseband processor 130 may detect an SSS in the frequency domain and may determine, from the detected SSS, the frame timing of the cell and the cell group ID to which the cell belongs. The baseband processor 130 may perform PBCH decoding to obtain information about the index of the synchronization signal. By using the obtained information and performing PBCH decoding, the baseband processor 130 may perform initial access to the cell.

The user equipment 100a may divide each frequency band by a preset unit into a plurality of sub-bands with respect to the entire supportable frequency band, determine at least one effective sub-band from among the plurality of sub-bands, and perform a frequency search operation on the effective sub-band, and thus, may find a target frequency faster than when a frequency search operation is performed on the entire frequency band. Accordingly, the initial access time may be reduced and thus the power consumption of the user equipment 100a may be reduced and the performance thereof may be improved, when compared to a related user equipment.

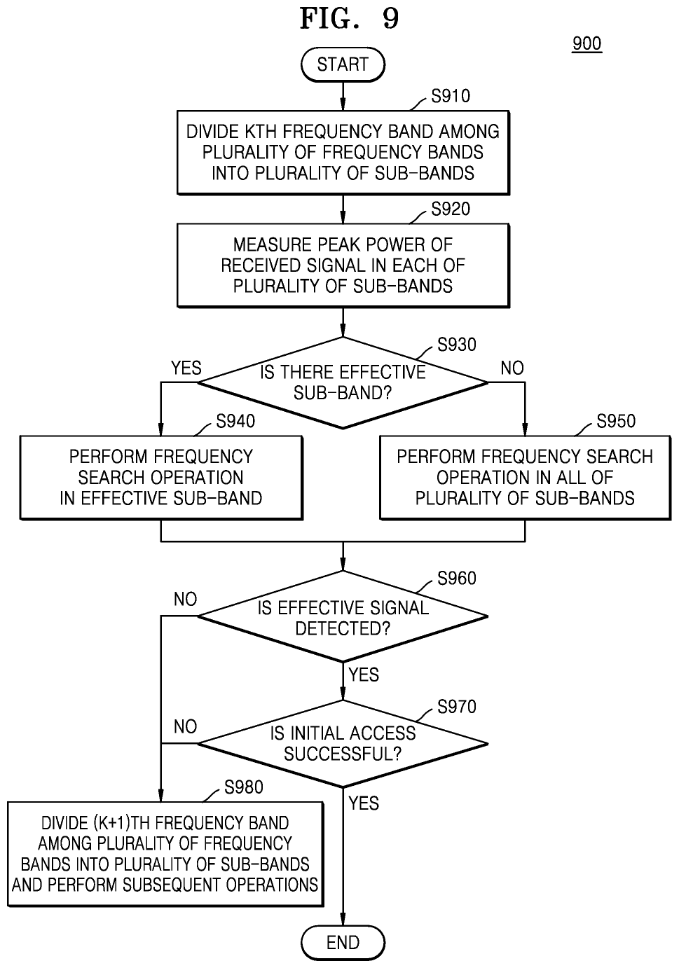

FIG. 9 is a flowchart illustrating a method of initially accessing a cell by a user equipment, according to an embodiment. Referring to FIG. 9, a method 900 of a user equipment initially accessing a cell may include a plurality of operations S910 to S980. The method 900 of a user equipment initially accessing a cell may include and/or may be similar in many respects to the method 200 of FIG. 2, and may include additional features not mentioned above. Consequently, repeated descriptions of the method 900 described above with reference to FIG. 2 may be omitted for the sake of brevity.

Referring to FIGS. 1 and 9, in operation S910, the user equipment 100 may divide a Kth frequency band from among a plurality of frequency bands into a plurality of sub-bands. K may refer to a positive integer greater than or equal to one (1). In some embodiments, the user equipment 100 may sequentially select a plurality of frequency bands and perform a cell search according to the present disclosure. For example, the user equipment 100 may perform a cell search by selecting a first frequency band from among a plurality of frequency bands and, when failing in the cell search, may perform a cell search by selecting a second frequency band. In operation S920, the user equipment 100 may measure a peak power in each of the plurality of sub-bands.

In operation S930, the user equipment 100 may determine an effective sub-band from among the plurality of sub-bands. When there is an effective sub-band (YES in operation S930), the user equipment 100 may perform a frequency search operation in the effective sub-band in operation S940. In some embodiments, the user equipment 100 may detect a peak value when there is a correlation component between the reference signal sequences and the SSB in the effective sub-band.

When there is no effective sub-band in operation S930 (NO in operation S930), the user equipment 100 may perform a frequency search operation in all of the plurality of sub-bands in operation S950. In some embodiments, the user equipment 100 may detect a peak value when there is a correlation component between the reference signal sequences and the SSB in all of the N sub-bands when all of the N sub-bands are determined as ineffective sub-bands.

In operation S960, the user equipment 100 may determine whether an effective signal is detected. In some embodiments, the user equipment 100 may detect an effective signal (e.g., a PSS or an SSS) in the sub-band when the peak value is detected and/or may not detect an effective signal in the sub-band when the peak value is not detected.

When the effective signal is detected in operation S960 (YES in operation S960), the user equipment 100 may attempt the initial access in operation S970. In some embodiments, the effective signal may include a PSS, and the user equipment 100 may determine, from the detected PSS, timing information of the cell, the position of an SSS, and a cell ID in a cell ID group. Thereafter, the user equipment 100 may detect an SSS in the frequency domain and may determine, from the detected SSS, the frame timing of the cell and the cell group ID to which the cell belongs. Based on the obtained information, the user equipment 100 may attempt initial access to the cell.

When the effective signal is not detected in operation S960 (NO in operation S960) and/or when the initial access to the cell fails in operation S970 (NO in operation S970), the user equipment 100 may perform operations S910 to S970 on a (K+1)th frequency band from among the plurality of frequency bands. For example, when the user equipment 100 fails to detect an effective signal in a plurality of sub-bands of the first frequency band (NO in operation S960) and/or fails to perform the initial access even when the effective signal is detected (NO in operation S970), the user equipment 100 may divide a second frequency band from among the plurality of frequency bands by a preset frequency size into L sub-bands and measure the power of each of the L sub-bands, where L is a positive integer greater than zero. Descriptions of the subsequent processes may be omitted for the sake of brevity.

When the initial access to the cell succeeds in operation S970 (YES in operation S970), the user equipment 100 may end the frequency search operation. For example, when the user equipment 100 succeeds in initial access to a particular cell by detecting an effective signal in a particular sub-band of the first frequency band, the user equipment 100 may end a frequency search operation on the frequency bands on which a frequency search operation has not yet been performed.

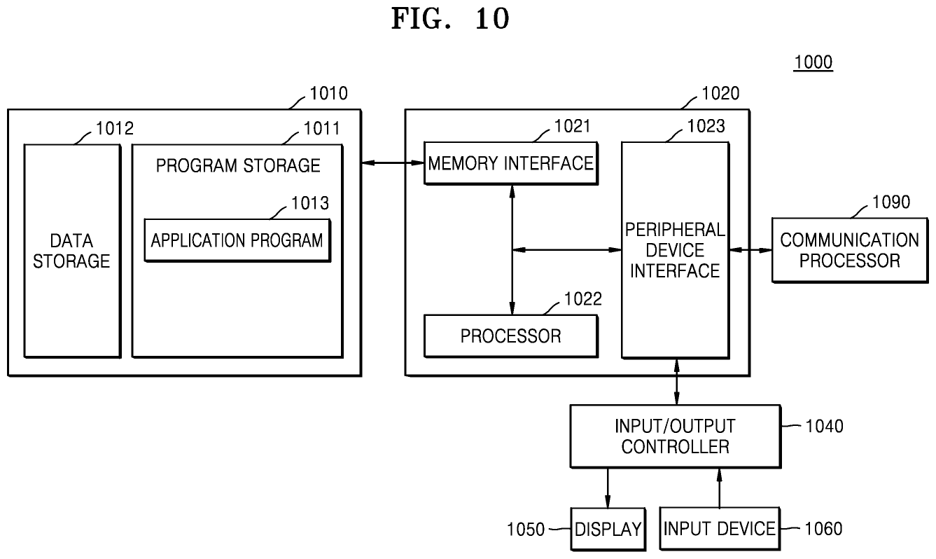

FIG. 10 is a block diagram illustrating an electronic device, according to an embodiment.

Referring to FIG. 10, an electronic device 1000 may include a memory 1010, a processor unit 1020, an input/output (I/O) controller 1040, a display 1050, an input device 1060, and a communication processor 1090. In some embodiments, the memory 1010 may be provided as a plurality of memories.

The memory 1010 may include a program storage 1011 storing a program for controlling an operation of the electronic device 1000 and a data storage 1012 storing data generated during execution of the program. The data storage 1012 may store data required for the operation of an application program 1013 and a data demodulation program and/or may store data generated from the operation of the application program 1013 and the data demodulation program. The memory 1010 may have any structure for storing data. For example, the memory 1010 may include a volatile memory device such as, but not limited to, a dynamic random access memory (DRAM) and/or a static random access memory (SRAM) and/or may include a nonvolatile memory device such, but not limited to, as a flash memory and/or a resistive random access memory (RRAM).

The program storage 1011 may include the application program 1013. As used herein, the program included in the program storage 1011 may be and/or may include a set of instructions and may be represented as an instruction set. The application program 1013 may include program codes for executing various applications operating in the electronic device 1000. That is, the application program 1013 may include codes (and/or commands) related to various applications driven by a processor 1022.

The electronic device 1000 may include the communication processor 1090 that may be configured to perform a communication function for voice communication and data communication. A peripheral device interface 1023 may control the connection between the input/output controller 1040, the communication processor 1090, the processor 1022, and a memory interface 1021. By using at least one software program, the processor 1022 may control a plurality of base stations to provide a service corresponding thereto. That is, the processor 1022 may execute at least one program stored in the memory 1010 and provide a service corresponding to the program.

The processor 1022 may perform the frequency search operation described above with reference to FIGS. 1 to 9 and attempt initial access to a cell based on the frequency search operation. In some embodiments, the processor 1022 may divide each of a plurality of frequency bands by a predetermined unit into N sub-bands based on the RAT supported by the electronic device 1000, measure the peak power of a received signal in each of the N sub-bands, and determine at least one effective sub-band from among the N sub-bands. The processor 1022 may detect an effective signal by performing a frequency search operation using a correlation component of a synchronization signal corresponding to the effective sub-band. The processor 1022 may perform initial access to the cell based on the detected effective signal. Because the processor 1022 divides each frequency band into a plurality of preset sub-bands with respect to the entire supportable frequency band, the processor 1022 may find a target frequency faster than when a frequency search operation is performed on the entire frequency band. Accordingly, the initial access time may be reduced and thus the power consumption of the electronic device 1000 may be reduced and the performance thereof may be improved, when compared to related electronic devices.

The input/output controller 1040 may provide an interface between the peripheral device interface 1023 and an input/output device such as the display 1050 and the input device 1060. The display 1050 may display status information, input text, moving pictures, still pictures, and the like. For example, the display 1050 may display application program information driven by the processor 1022.

The input device 1060 may provide input data generated by selection by the electronic device 1000, to the processor unit 1020 through the input/output controller 1040. For example, the input device 1060 may include a keypad including at least one hardware button and a touch pad for sensing touch information. As another example, the input device 1060 may provide touch information such as a touch, a touch movement, and a touch release detected through the touch pad, to the processor 1022 through the input/output controller 1040.

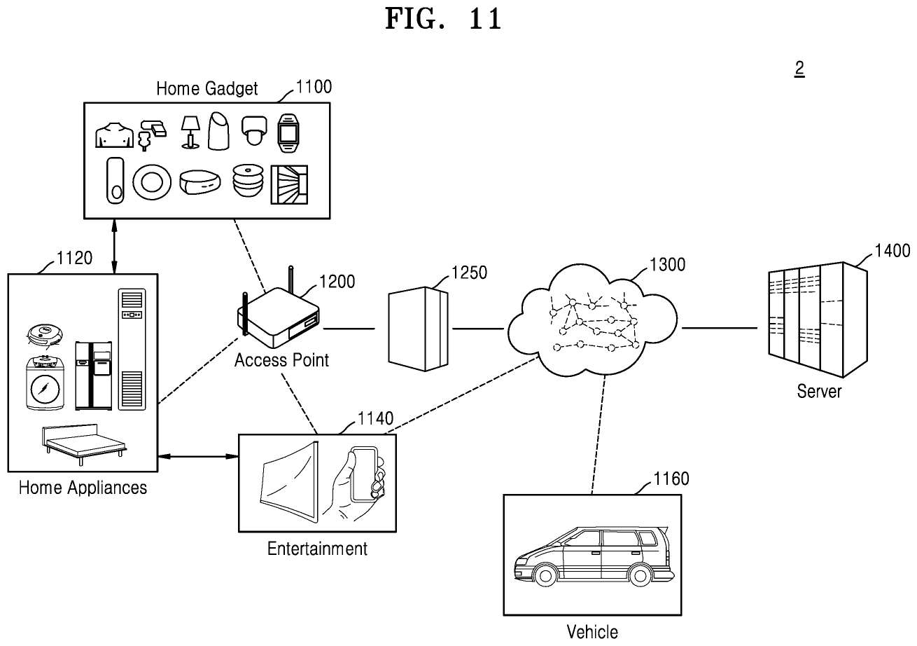

FIG. 11 is a conceptual diagram illustrating an Internet of Things (IoT) network system to which an embodiment is applied.

Referring to FIG. 11, an IoT network system 2 may include a plurality of IoT equipment (e.g., home gadgets 1100, home appliances 1120, entertainment equipment 1140, and vehicles 1160), an access point 1200, a gateway 1250, a wireless network 1300, and a server 1400. As used herein, IoT may refer to a network between things (e.g., devices, equipment) using wired/wireless communication.

Each of the IoT equipment 1100 to 1160 may form a group according to the characteristics of each IoT equipment. For example, the IoT equipment 1100 to 1160 may be grouped into a home gadget group 1100, a home appliance/furniture group 1120, an entertainment group 1140, a vehicle group 1160, and the like. At least a portion of the IoT equipment (e.g., home gadgets 1100, home appliances 1120, and entertainment equipment 1140) may be connected to a communication network or to another IoT equipment through the access point 1200. The access point 1200 may be built in one IoT equipment. The gateway 1250 may change the protocol to connect the access point 1200 to an external wireless network. The IoT equipment (e.g., home gadgets 1100, home appliances 1120, and entertainment equipment 1140) may be connected to an external communication network through the gateway 1250. The wireless network 1300 may include the Internet and/or a public network. The IoT equipment 1100 to 1160 may be connected through a wireless network 1300 to the server 1400 providing a certain service, and the user may use a service through at least one of the IoT equipment 1100 to 1160.

According to embodiments, the IoT equipment 1100 to 1160 may perform the frequency search operation described above with reference to FIGS. 1 to 9 and attempt initial access to a cell based thereon. In some embodiments, the IoT equipment 1100 to 1160 may divide each of a plurality of frequency bands by a predetermined unit into N sub-bands based on the RAT supported by the IoT equipment 1100 to 1160, measure the peak powers of a received signal in each of the N sub-bands, and determine an effective sub-band from among the N sub-bands. The IoT equipment 1100 to 1160 may detect an effective signal by performing a frequency search operation using a correlation component of a synchronization signal corresponding to the effective sub-band. The IoT equipment 1100 to 1160 may perform initial access to the cell based on the detected effective signal. Because the IoT equipment 1100 to 1160 divides each frequency band into a plurality of preset sub-bands with respect to the entire supportable frequency band, the IoT equipment 1100 to 1160 may find a target frequency faster than when a frequency search operation is performed on the entire frequency band. Accordingly, the initial access time may be reduced and thus the power consumption of the electronic device 1000 may be reduced and the performance thereof may be improved, when compared to related electronic devices.

While certain example embodiments of the present disclosure have been particularly shown and described, it is to be understood that various changes in form and details may be made therein without departing from the spirit and scope of the following claims.

What is claimed is:

1. An operating method of a user equipment in a wireless communication system, the operating method comprising:
dividing a first frequency band, from among a plurality of frequency bands, into a plurality of sub-bands, according to a first radio frequency technology (RAT);
measuring peak powers of each sub-band of the plurality of sub-bands;
determining at least one effective sub-band from among the plurality of sub-bands, based on the measured peak powers;
detecting, based on the determining the at least one effective sub-band, a first effective signal through a frequency search operation using a correlation component of a synchronization signal corresponding to the first frequency band or the at least one effective sub-band; and
performing initial access to a cell, based on the detecting the first effective signal.

2. The operating method of claim 1, wherein the determining the at least one effective sub-band comprises:
extracting maximum peak powers of the plurality of sub-bands from the measured peak powers; and
determining, as the at least one effective sub-band, a first sub-band corresponding to at least one maximum peak power greater than or equal to a first threshold, from among the extracted maximum peak powers.

3. The operating method of claim 2, wherein the determining the at least one effective sub-band further comprises:
measuring a noise of a second sub-band corresponding to at least another maximum peak power less than the first threshold, from among the extracted maximum peak powers;
generating adjusted maximum peak powers of the plurality of sub-bands by subtracting measured noises from maximum peak powers of the second sub-band; and
determining, as the at least one effective sub-band, at least one sub-band corresponding to at least one adjusted maximum peak power greater than or equal to a second threshold, from among the adjusted maximum peak powers.

4. The operating method of claim 3, wherein the noise comprises an average of one or more lower peak powers from among the measured peak powers of the second sub-band, and
wherein the one or more lower peak powers are less than remaining peak powers from among the measured peak powers of the second sub-band.

5. The operating method of claim 1, wherein the determining the at least one effective sub-band comprises excluding, based on time indexes of the measured peak powers, at least one sub-band of the plurality of sub-bands from the determining the at least one effective sub-band.

6. The operating method of claim 5, wherein the determining the at least one effective sub-band further comprises reducing, based on the time indexes of the measured peak powers, a priority of at least another sub-band from among the plurality of sub-bands used in the determining the at least one effective sub-band.

7. The operating method of claim 5, wherein the excluding the at least one sub-band comprises excluding a sub-band of the plurality of sub-bands corresponding to the measured peak powers such that a second interval between the time indexes according to a second RAT is different from a first interval of the first RAT.

8. The operating method of claim 1, wherein the detecting the first effective signal comprises, based on the at least one effective sub-band not being detected, detecting the first effective signal through the frequency search operation using the correlation component of the synchronization signal corresponding to the first frequency band.

9. The operating method of claim 1, wherein the performing the initial access to the cell comprises, based on the first effective signal not being detected or the performing the initial access to the cell based on the first effective signal being unsuccessful:
detecting a second effective signal based on measured peak powers of another plurality of sub-bands of a second frequency band from among the plurality of frequency bands; and
performing the initial access to the cell based on the detecting the second effective signal.

10. The operating method of claim 1, wherein the measuring of the peak powers comprises measuring, for each sub-band of the plurality of sub-bands, a peak power based on a received signal strength indicator (RSSI).

11. The operating method of claim 1, wherein the dividing the first frequency band into the plurality of sub-bands comprises dividing the first frequency band by a preset frequency size into N sub-bands based on the first RAT, and
wherein N is a positive integer greater than zero.

12. An operating method of a user equipment in a wireless communication system, the operating method comprising:
dividing a first frequency band, from among a plurality of frequency bands, by a preset frequency size into N sub-bands, according to a first radio frequency technology (RAT), wherein N is a positive integer greater than zero;
measuring peak powers of each sub-band of the N sub-bands;
determining at least one effective sub-band from among the N sub-bands, based on the measured peak powers;
detecting, based on the determining the at least one effective sub-band, a first effective signal by performing a frequency search operation using a correlation component of a synchronization signal corresponding to the first frequency band or the at least one effective sub-band; and
performing initial access to a cell, based on the detecting of the first effective signal.

13. The operating method of claim 12, wherein the determining the at least one effective sub-band comprises:
extracting maximum peak powers of the N sub-bands from the measured peak powers; and
determining, as the at least one effective sub-band, at least one sub-band corresponding to at least one maximum peak power greater than or equal to a first threshold, from among the extracted maximum peak powers.

14. The operating method of claim 12, wherein the determining the at least one effective sub-band comprises:
measuring noises of the N sub-bands;
generating adjusted peak powers of the N sub-bands by subtracting the measured noises from the measured peak powers;
extracting maximum peak powers of the N sub-bands from the adjusted peak powers; and
determining, as the at least one effective sub-band, at least one sub-band corresponding to at least one maximum peak power greater than or equal to a second threshold, from among the extracted maximum peak powers.

15. The operating method of claim 14, wherein each of the noises comprises an average of one or more lower peak powers from among the measured peak powers of the N sub-bands, and
wherein the one or more lower peak powers are less than remaining peak powers from among the measured peak powers of the N sub-bands.

16. The operating method of claim 12, wherein the determining the at least one effective sub-band comprises excluding a sub-band of the N sub-bands corresponding to the measured peak powers such that a second interval between time indexes of the measured peak powers according to a second RAT is different from a first interval of the first RAT.

17. The operating method of claim 12, wherein the performing the initial access to the cell comprises, based on the first effective signal not being detected or the performing of the initial access to the cell based on the first effective signal being unsuccessful:
detecting a second effective signal based on measured peak powers of a plurality of sub-bands of a second frequency band from among the plurality of frequency bands; and
performing the initial access to the cell based on the detecting the second effective signal.

18. A user equipment for wireless communication, the user equipment comprising:
a power measurement circuit configured to measure peak powers of a first frequency band, from among a plurality of frequency bands, in units of sub-bands; and
a baseband processor configured to:
receive the peak powers from the power measurement circuit;
determine an effective sub-band based on the peak powers;
detect a synchronization signal by performing a frequency search operation using a correlation component of the synchronization signal corresponding to the first frequency band or the effective sub-band; and
perform initial access to a cell based on the detected synchronization signal.

19. The user equipment of claim 18, wherein the baseband processor is further configured to:
perform, based on the effective sub-band not being detected, the frequency search operation using the correlation component of the synchronization signal corresponding to the first frequency band.

20. The user equipment of claim 18, wherein the baseband processor is further configured to:
determine, as the effective sub-band, a first sub-band corresponding to a peak power greater than or equal to a first threshold, from among the peak powers, and
wherein the first sub-band comprises at least one sub-band of the first frequency band divided in units of the sub-bands.
